(19) United States
(12) Patent Application Publication
(10) Pub. No.: US 2020/0326447 A1
(43) Pub. Date: Oct. 15, 2020

(54) COLLIMATOR, COLLIMATOR MOUNTING DEVICE AND METHOD, AND SECURITY INSPECTION MACHINE

(71) Applicant: Nuctech Company Limited, Beijing (CN)

(72) Inventors: Ximeng Li, Beijing (CN); Qinchan Wang, Beijing (CN); Zhongrong Yang, Beijing (CN); Jinyu Zhang, Beijing (CN)

(21) Appl. No.: 16/319,691

(22) PCT Filed: Aug. 9, 2017
(86) PCT No.: PCT/CN2017/096541

§ 371 Date: Jan. 22, 2019

(30) Foreign Application Priority Data
Nov. 16, 2016 (CN) 201611022252.X

(51) Int. Cl. G01V 5/00; G21K 1/02; G02B 27/30

(52) U.S. Cl. CPC G01V 5/0008; G02B 27/30; G21K 1/02

(57) ABSTRACT

The present disclosure relates to a collimator and a collimator mounting device and method, which belong to the technical field of accessories of the X-ray security inspection machine. The collimator comprises a T-shaped base plate and two lead plates, wherein the two lead plates are arranged side by side and in parallel to each other, and are fixed on a longitudinal plate of the T-shaped base plate and extends to a transverse plate of the T-shaped base plate. The collimator is inserted obliquely into a shielding box, with a gap between the two lead plates in the collimator aligned with a first ray opening.

### TECHNICAL FIELD

The present disclosure relates to the technical field of X-ray security equipment accessories, and in particular relates to a collimator and a collimator mounting device.

### BACKGROUND

A collimating device of a security inspection machine can be composed of two lead-antimony alloy plates that can block rays and are mounted side by side on a base plate, with a narrow gap left between the two plates to allow useful rays to pass through. The collimating device is usually mounted in a box for shielding the rays. Due to inevitable machining and assembly errors and deformation of supporting members, the collimating device generally needs to be adjusted on a left and right direction so that main beam of the rays can illuminate onto a detector plate by passing through the gap between the two plates.

There are generally two kinds of arrangements for fixing the collimating device. One arrangement is shown in FIG. 1, where a collimator 1 is completely contained within a shielding box 2, and is adjusted and fixed by screws 3. With such an adjustment and mounting arrangement by use of screws, it is very inconvenient to remove the collimator, and it is necessary to remove the shielding box as a whole before removing the collimator. Moreover, it is very difficult to adjust a width of a collimating slit during adjustment of the equipment. The other arrangement is shown in FIG. 2, where two opposite ends of a collimator 1 are fixed by screws outside of a shielding box 2, and the collimator 1 is adjusted by left and right set screws 4. Since the two opposite ends of the collimator are disposed out of the shielding box and are fixed by screws, in the case that the shielding box is mounted vertically in a side view, people cannot operate the lower left and right set screws in a standing posture because the left and right set screws are located at the bottom of the equipment. In addition, electrical components are generally arranged at the bottom of the equipment, and thus occupy operating space of the left and right set screws, resulting in that it is necessary to remove the electrical components to make adjustment space.

In the above two arrangements for fixing the collimating device, since the collimator is arranged in parallel with channel wall surfaces, it is necessary for the collimating device to have dimensions larger than (the second arrangement) or slight smaller than (the first arrangement) the channel in length and width directions of the channel, to achieve the collimation for the entire channel. For large-channel security inspection machine, this will bring a collimator with very large length and weight, and it is easy for the collimator to deform. Besides, a width of the collimating slit is generally about 1 mm, and a width of the rays having passed through the collimating slit will be magnified by a certain ratio depending on specific structure of the collimating device and the detector plate. As shown in FIG. 3, a width of the rays projecting on an end detector plate 5 is L4=L3×L2/L1. In various actual types of the machines, L2/L1 is slightly larger than 1. If the width of the collimating slit is 1 mm. L4 is also slightly larger than 1 mm. However, an illumination width of the rays on a detector plate 6 at other positions is significantly larger than that on the end detector plate, and a too narrow illumination width may tend to cause a difficult alignment among a strip crystal of detector plate, the collimating slit, and a target. (In FIG. 3, L1: a distance between a target of an irradiation machine and a collimator, L2: a distance between the target of the irradiation machine and a strip crystal of detector plate, L3: the width of the collimating slit, and L4: a width of rays projecting on the detector plate after passing through the collimating slit).

### SUMMARY

It is an object of the present disclosure to provide a collimator with a more rational configuration and easy to be adjusted, and a mounting device thereof.

To this end, the present disclosure employs the following technical solutions:
A collimator, characterized in that, comprising:
a T-shaped base plate; and
two lead plates arranged side by side and in parallel to each other, wherein the two lead plates are fixed to a longitudinal plate of the T-shaped base plate and extend to a transverse plate of the T-shaped base plate.

As a preferred embodiment, the two lead plates are arranged such that two opposite ends of each lead plate are aligned with one end of the longitudinal plate of the T-shaped base plate and an edge of the transverse plate respectively, and respective outer sides of the lead plates are aligned with two opposite sides of the longitudinal plate respectively.

As a preferred embodiment, the T-shaped base plate comprises folded portions at its edges which face the lead plates.

As a preferred embodiment, the transverse plate of the T-shaped base plate further comprises fixing holes at its four corners.

As a preferred embodiment, each fixing hole is formed as a kidney-shaped slot.

The present disclosure further provides a collimator mounting device, comprising: a shielding box, and the shielding box comprises a first ray opening, wherein the collimator according to any embodiments as described above is obliquely inserted into the shielding box with a gap between the two lead plates of the collimator aligned with the first ray opening.

As a preferred embodiment, the shielding box is formed in a box shape constituted by an intermediate connecting plate, a left plate, a right plate and a cover plate, wherein the first ray opening is provided in the intermediate connecting plate, the transverse plate of the T-shaped base plate in the collimator is obliquely inserted on the left and right plates, and an acute angle is formed between the collimator and the intermediate connecting plate.

As a preferred embodiment, a supporting plate is obliquely disposed between the left and right plates, wherein the supporting plate comprises a second ray opening; the collimator is mounted on the supporting plate with the gap between the two lead plates aligned with the second ray opening.

As a preferred embodiment, a left adjusting box is provided on the left plate and a right adjusting box is provided on the right plate, wherein two opposite sides of the transverse plate of the T-shaped base plate are accommodated within the left and right adjusting boxes respectively, and the T-shaped base plate is fixedly connected to the left and right adjusting boxes after a fine adjustment of the collimator is completed.

As a preferred embodiment, each of the left and right plates comprises a groove, and the supporting plate is disposed adjacent to the grooves and parallel to an extending direction of the grooves, wherein the transverse plate of the T-shaped base plate is inserted into the grooves, and the collimator mounting device further comprises a top cover covering the grooves.

The present disclosure further provides a security inspection machine, comprising a radiation emitting device, and the radiation emitting device is applied with the collimator according to any embodiments as described above.

The present disclosure further provides a security inspection machine, comprising a radiation emitting device, and the radiation emitting device is applied with the collimator according to any embodiments, and the security inspection machine comprises the collimator mounting device according to any embodiments as described above for mounting the collimator.

The present disclosure further provides a method of mounting a collimator to a collimator mounting device, comprising steps of:
inserting a collimator obliquely into left and right plates along a supporting plate, wherein a transverse plate of a T-shaped base plate in the collimator is placed in grooves of the left and right plates, and two opposite sides of the transverse plate are accommodated within left and right adjusting boxes respectively;
adjusting a position of the collimator to align a gap between two lead plates with a first ray opening and a second ray opening;
fixedly connecting the left and right adjusting boxes with the T-shaped base plate, after finely adjusting a position of the T-shaped base plate in the collimator; and
covering a top cover on the grooves.

In the collimator, the collimator mounting device and the collimator mounting method of the present disclosure, the base plate of the collimator is a member of T-shape, which not only can provide sufficient mounting space for the two lead plates, thus shortening the length of the lead plates to reduce deformation, but also can facilitate the insertion of the collimator so as to enable the collimator to be directly and obliquely inserted into the shielding box, facilitating the assembly, disassembly and adjustment of the collimator. Moreover, the operation position is located in the middle of the device in a height direction, the operating height is moderate, and thus the operator can make an operation in a standing posture for most of the security inspection machines with such a device, which is convenient and labor-saving. Further, the arrangement space of the electrical components at the bottom of the device will not be occupied, which can solve the problem that the end detector plate has a small illumination area, and also can solve the problem that the collimator is difficult to be adjusted. Also, it is easier to assemble and adjust the security inspection machine using the collimator and the collimator mounting device provided by the present disclosure.

### BRIEF DESCRIPTION OF THE DRAWINGS

FIG. 1 is a side view of a first conventional collimator mounting device.

FIG. 2 is a side view of a second conventional collimator mounting device.

FIG. 3 is an explanatory diagram of a ray width during an operation of a conventional collimator mounting device.

FIG. 4 is a perspective view of a collimator according to an embodiment of the present disclosure.

FIG. 5 is an exploded view of a collimator mounting device according to an embodiment of the present disclosure.

FIG. 6 is a perspective view of a collimator mounting device according to an embodiment of the present disclosure.

FIG. 7 is a schematic view of disassembly and assembly of a collimator mounting device according to an embodiment of the present disclosure.

FIG. 8 is a cross-sectional view taken along the line D-D of FIG. 7.

FIG. 9 is an explanatory diagram of a ray width during operation of a collimator mounting device according to an embodiment of the present disclosure.

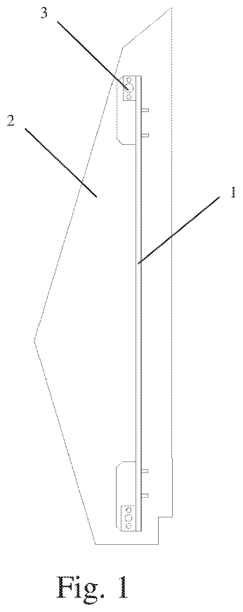

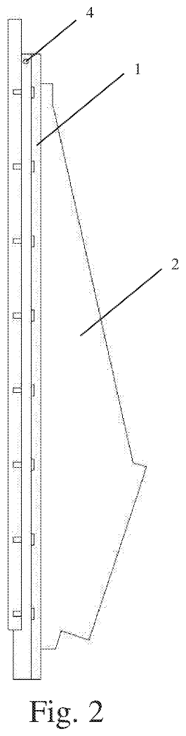

In FIG. 1 to FIG. 3: 1—collimator, 2—shielding box, 3—screw, 4—left and right set screws, 5—end detector plate, 6—detector plate.

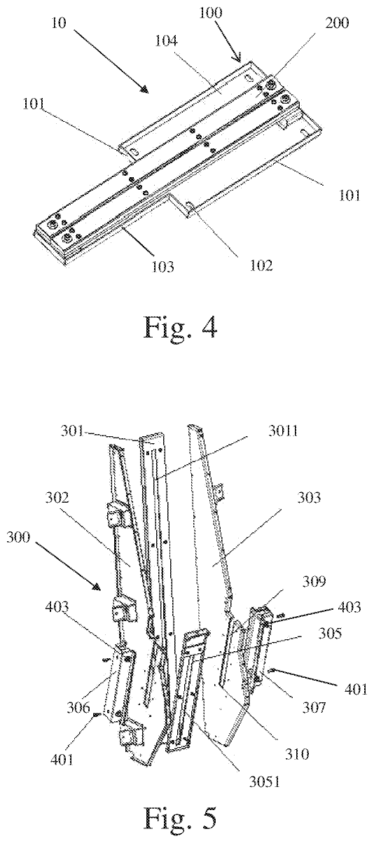

In FIG. 4 to FIG. 8: 10—collimator, 11—end detector plate, 100—T-shaped base plate, 101—folded portion, 102—fixing hole, 103—longitudinal plate of the T-shaped base plate, 104—transverse plate of the T-shaped base plate, 200—lead plate, 300—shielding box, 301—connecting plate, 3011—first ray opening, 302—left plate, 303—right plate, 304—cover plate, 305—supporting plate, 3051—second ray opening, 306—left adjusting box, 307—right adjusting box, 308—top cover, 309—groove, 310—stopping portion, 401—adjusting screw, 402—locking nut, 403—fixing screw, 404—fixing nut.

### DETAILED DESCRIPTION

The technical solutions of the present disclosure will be further described below in conjunction with the accompanying drawings and specific embodiments.

As shown in FIG. 4, a collimator 10 includes a T-shaped base plate 100 and two lead plates 200. The two lead plates 200 are arranged side by side and in parallel to each other, fixed on a longitudinal plate 103 of the T-shaped base plate 100 and extends to a transverse plate 104, wherein a surface of each lead plate 200 which is fitted onto the T-shaped base plate 100 is a mounting surface. In order to facilitate mounting and to minimize the device to a smallest useful size, two opposite ends of each lead plate 200 are aligned with one end of the longitudinal plate 103 of the T-shaped base plate 100 and an edge of the transverse plate 104 of the T-shaped base plate 100 respectively, and respective outer sides of the two lead plates 200 are aligned with two opposite sides of the longitudinal plate 103, respectively. Preferably, the T-shaped base plate 100 comprises folded portions 101 at its edges which face the lead plates 200, that is, the folded portions 101 are disposed at the same side with the mounting surfaces of the lead plates 200. The folded portions 101 can improve the strength of the T-shaped base plate 100, and meanwhile part of the folded portions 101 can function as engaging members and connecting members when the collimator 10 is mounted. In order to facilitate the mounting of the collimator 10, the transverse plate 104 of the T-shaped base plate 100 further comprises fixing holes 102 at its four corners, for performing bolt fastening on the collimator 10. In order to facilitate position adjustment during the bolt fastening, the fixing hole 102 is designed as a kidney-shaped hole.

As shown in FIG. 5 to FIG. 8, a collimator mounting device includes a shielding box 300. The shielding box 300 comprises a first ray opening 3011. The collimator 10 as described above is obliquely inserted into the shielding box 300, with a gap between the two lead plates 200 in the collimator 10 aligned with the first ray opening 3011.

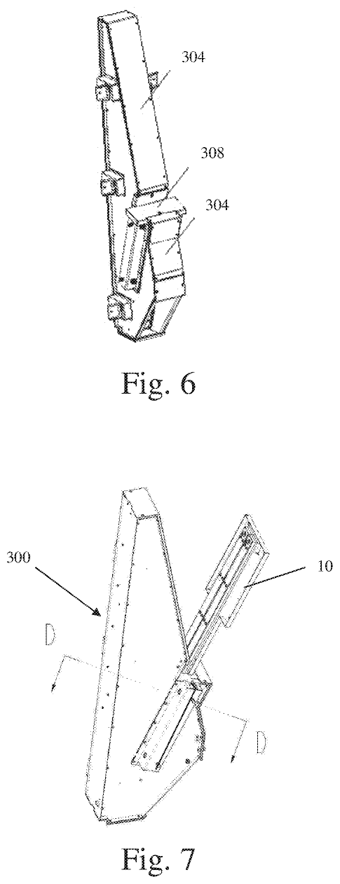

Specifically, as shown in FIG. 5, the shielding box 300 is constituted by an intermediate connecting plate 301, a left plate 302, a right plate 303, and a cover plate 304 (as shown in FIG. 6, the cover plate 304 is divided into two parts), wherein the first ray opening 3011 is provided in the intermediate connecting plate 301. The transverse plate 104 of the T-shaped base plate 100 in the collimator 10 is obliquely inserted onto the left and right plates 302, 303. Each of the left and right plates 302 and 303 comprises an oblique groove 309, into which the transverse plate 104 of the T-shaped base plate 100 in the collimator 10 can be inserted, and each groove 309 extends in an acute angle relative to the intermediate connecting plate 301. Each groove 309 comprises a stopping edge 310 at its bottom. In the case that the transverse plate 104 of the T-shaped base plate 100 is inserted into the grooves 309, the folded portions 101 at the edges of the transverse plate 104 connected to the longitudinal plate 103 engage with the stopping edges 310. In order to facilitate the insertion of the collimator 10 onto the left and right plates 302, 303, a supporting plate 305 is obliquely disposed between the left and right plates 302, 303. The supporting plate 305 is disposed adjacent to and parallel to the grooves 309, and not only can serve as a guide for the mounting of the collimator 10, but also can support the collimator 10 thereon. In the case that the collimator 10 is inserted into place, the T-shaped base plate 100 abuts against the supporting plate 305. Since the supporting plate 305 is parallel to an extending direction of the grooves 309, the same acute angle is formed between the intermediate connecting plate 301 and the supporting plate 305. Therefore, the same acute angle is also formed between the collimator 10 and the intermediate connecting plate 301. The supporting plate 305 comprises a second ray opening 3051, wherein the gap between the two lead plates 200 is aligned with the second ray opening 3051, after the collimator 10 is disposed on the supporting plate 305.

In order to facilitate fine position adjustment of the collimator 10 relative to the shielding box 300, as shown in FIG. 5, the left and right plates 302, 303 are respectively provided with a left adjusting box 306 and a right adjusting box 307. Two opposite sides of the transverse plate 104 of the T-shaped base plate 100 in the collimator 10 are respectively accommodated within the left and right adjusting boxes 306, 307 after protruding out of the grooves 309. As shown in FIG. 8, each of the left and right adjusting boxes 306, 307 is provided with an adjusting screw 401 and a locking nut 402. The adjusting screw 401 on the left adjusting box 306 is arranged to pass through the locking nut 402 and the left adjusting box 306 sequentially, with an end portion abutting against the folded portion 101 at the edge on one side (left side as shown in FIG. 8) of the transverse plate 104 of the T-shaped base plate 100, and the adjusting screw 401 on the right adjusting box 307 is arranged to pass through the locking nut 402 and the right adjusting box 307 sequentially, with an end portion abutting against the folded portion 101 at the edge on the other side (right side as shown in FIG. 8) of the transverse plate 104 of the T-shaped base plate 100. As a result, the fine adjustment of the collimator on the left and right direction can be achieved by adjusting the adjusting screws 401 on the left and right sides of the shielding box. After the adjustment is completed, as shown in FIG. 5 and FIG. 8, fixing screws 403 are arranged to respectively pass through the left and right adjusting boxes 306 and 307 and the corresponding fixing holes 102 on the T-shaped base plate 100, and then screwed to their respective fixing nuts 404, so as to complete the fixing of the collimator 10.

Finally, a top cover 308 can be used to cover the grooves 309, thereby completing the mounting of the collimator 10. As shown in FIG. 6, after the mounting is completed, the top cover 308 is inserted on the left and right plates 302, 303.

The specific process of mounting the collimator 10 to the shielding box 300 is described as below.

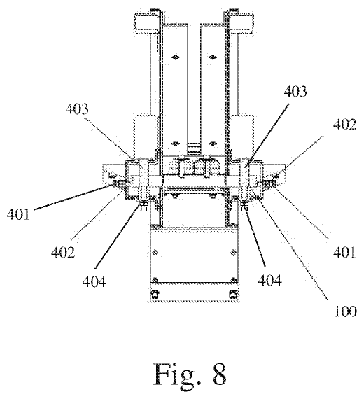

As shown in FIGS. 7 and 8, at first, the collimator 10 is inserted into the shielding box along the supporting plate 305, with the transverse plate of the T-shaped base plate 100 in the collimator 10 placed in the grooves 309 of the left and right plates 302, 303. In the case that the collimator 10 is inserted in position, the folded portions 101 at the edges of the transverse plate 104 of the T-shaped base plate 100 connected to the longitudinal plate 103 engage with the stopping edges 310. In this state, as shown in FIG. 6, the T-shaped base plate 100 abuts against the supporting plate 305, the gap between the two lead plates 200 is aligned with the first ray opening 3011 and the second ray opening 3051, and two opposite sides of the transverse plate 104 of the T-shaped base plate 100 are accommodated within the left and right adjusting boxes 306, 307, respectively. As shown in FIG. 8, when the collimator 10 needs to move right, loosening the locking nuts 402 for locking the adjusting screws 401 respectively on the left and right adjusting boxes 306, 307 and simultaneously adjusting the two adjusting screws 401 to the right, such that the adjusting screw 401 on the left adjusting box 306 presses against the left side folded portion 101 of the T-shaped base plate 100 and pushes the T-shaped base plate 100 to the right; after the collimator 10 is adjusted in position, simultaneously adjusting the two adjusting screws 401 towards the middle of the shielding box 300 such that the T-shaped base plate 100 is clamped; and finally, tightening the locking nuts 402. When the collimator 10 needs to move left, loosening the locking nuts 402 for locking the adjusting screws 401 respectively on the left and right adjusting boxes 306, 307 and then simultaneously adjusting the two adjusting screws 401 to the left, such that the adjusting screw 401 on the right adjusting box 307 presses against the right side folded portion 101 of the T-shaped base plate 100 and pushes the T-shaped base plate 100 to the left; after the collimator 10 is adjusted in position, simultaneously adjusting the two adjusting screws 401 towards the middle of the shielding box 300 such that the T-shaped base plate 100 is clamped; and finally, tightening the locking nuts 402. After the adjustment is finished, two fixing screws 403 are penetrated through the left adjusting box 306 and the respective fixing holes 102 on the T-shaped base plate 100 and then screwed to their respective fixing nuts 404, and another two fixing screws 403 are penetrated through the right adjusting box 307 and the respective fixing holes 102 on the T-shaped base plate 100 and then screwed to their respective fixing nuts 404, so as to complete the fixing of the collimator 10. Finally, as shown in FIG. 6, the top cover 308 is covered on the grooves 309, and the mounting of the collimator 10 is finished. The opposite steps can be performed when removing the collimator 10.

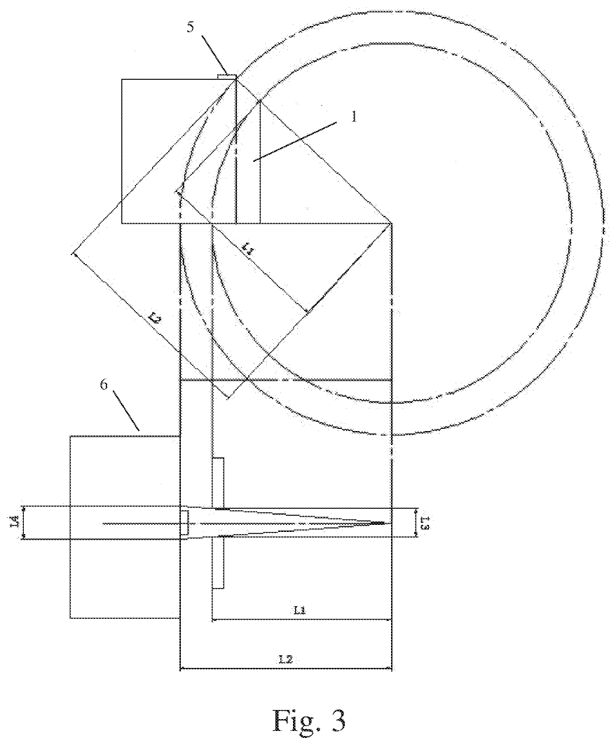

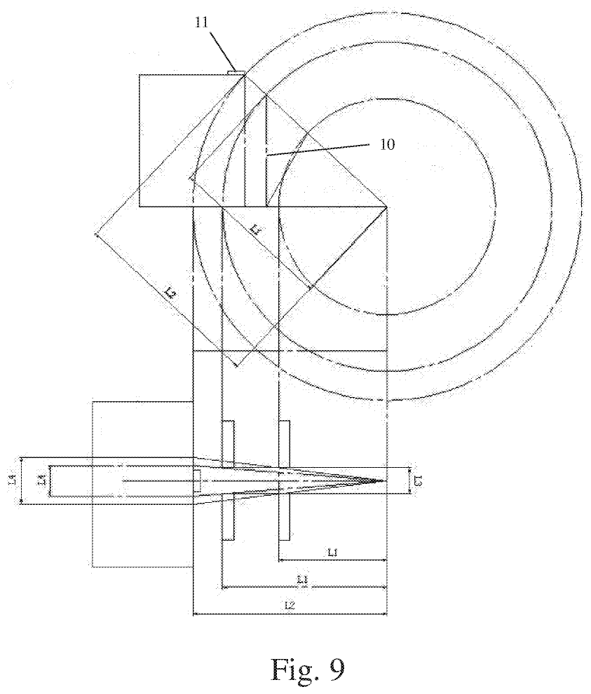

In the collimator 10 and the mounting device thereof as described above, the base plate is formed in a member of T-shape, which not only can provide sufficient mounting space for the two lead plates 200, thus shortening the length of the lead plates to reduce deformation, but also can facilitate the insertion of the collimator 10 so as to enable the collimator 10 to be directly and obliquely inserted on the shielding box 300, facilitating the assembly, disassembly and adjustment of the collimator 10. Moreover, the operator can directly operate on the device in a standing posture, which is convenient and labor-saving. Further, in the mounting device with the collimator obliquely inserted thereon, arrangement space of the electrical components at the bottom of the device are not occupied, which can solve the problem that the illuminated area on the end detector plate is small and that the collimator is difficult to be adjusted. As shown in FIG. 9, with an oblique collimator, an illuminated area on the end detector plate 11 has a larger width L4 (=L3×L2/L1) compared to the case that the collimator is disposed vertically (as shown in FIG. 3), resulting in that the plate is easy to adjust (in FIG. 9, L1: a distance between a target of a radiation machine and a collimator, L2: a distance between the target of the radiation machine and a strip crystal of detector plate, L3: a width of a collimating slit, and L4: a width of rays projecting on the detector plate after passing through the collimating slit).

The security inspection machine comprises a radiation emitting device which is applied with the collimator 10 provided in the embodiment, and further comprises the collimator mounting device as described above for mounting of the collimator. Thus, it is easier for assembly and adjustment of the security inspection machine.

It is apparent that the above-described embodiments of the present disclosure are merely illustrative of the present disclosure for clearly describing the present disclosure, and are not intended to limit the embodiments of the present disclosure. Other variations or changes of the various forms may be made by those skilled in the art in light of the above description. There is no need and no way to exhaust all of the implementations. Any modifications, equivalent substitutions and improvements made within the scope of the disclosure are intended to be included within the scope of the appended claims.

1. A collimator comprising:
a T-shaped base plate; and
two lead plates arranged side by side and in parallel to each other, wherein the two lead plates are fixed to a longitudinal plate of the T-shaped base plate and extend to a transverse plate of the T-shaped base plate.

2. The collimator according to claim 1, wherein the two lead plates are arranged such that two opposite ends of each lead plate are aligned with one end of the longitudinal plate of the T-shaped base plate and an edge of the transverse plate respectively, and respective outer sides of the lead plates are aligned with two opposite sides of the longitudinal plate respectively.

3. The collimator according to claim 1, wherein the T-shaped base plate comprises folded portions at its edges which face the lead plates.

4. The collimator according to claim 1, wherein the transverse plate of the T-shaped base plate further comprises fixing holes at its four corners.

5. The collimator according to claim 4, wherein each fixing hole is formed as a kidney-shaped slot.

6. A collimator mounting device for a collimator, wherein the collimator comprises:
a T-shaped base plate; and
two lead plates arranged side by side and in parallel to each other, wherein the two lead plates are fixed to a longitudinal plate of the T-shaped base plate and extend to a transverse plate of the T-shaped base plate,
the collimator mounting device further comprises a shielding box,
wherein the shielding box comprises a first ray opening and the collimator is obliquely inserted into the shielding box with a gap between the two lead plates of the collimator aligned with the first ray opening.

7. The collimator mounting device according to claim 6, wherein the shielding box is formed in a box shape constituted by an intermediate connecting plate, a left plate, a right plate and a cover plate, wherein the first ray opening is provided in the intermediate connecting plate, the transverse plate of the T-shaped base plate in the collimator is obliquely inserted on the left and right plates, and an acute angle is formed between the collimator and the intermediate connecting plate.

8. The collimator mounting device according to claim 7, wherein a supporting plate is obliquely disposed between the left and right plates, wherein the supporting plate comprises a second ray opening; the collimator is mounted on the supporting plate with the gap between the two lead plates aligned with the second ray opening.

9. The collimator mounting device according to claim 8, wherein a left adjusting box is provided on the left plate and a right adjusting box is provided on the right plate, wherein two opposite sides of the transverse plate of the T-shaped base plate are accommodated within the left and right adjusting boxes respectively, and the T-shaped base plate is fixedly connected to the left and right adjusting boxes after a fine adjustment of the collimator is completed.

10. The collimator mounting device according to claim 9, wherein each of the left and right plates comprises a groove, and the supporting plate is disposed adjacent to the grooves and parallel to an extending direction of the grooves, wherein the transverse plate of the T-shaped base plate is inserted into the grooves, and the collimator mounting device further comprises a top cover covering the grooves.

11. A security inspection machine comprising a radiation emitting device, wherein the radiation emitting device is applied with a collimator comprising:
a T-shaped base plate; and
two lead plates arranged side by side and in parallel to each other, wherein the two lead plates are fixed to a longitudinal plate of the T-shaped base plate and extend to a transverse plate of the T-shaped base plate.

12. The security inspection machine according to claim 11, further comprising a collimator mounting device for mounting the collimator,
wherein the collimator mounting device comprises a shielding box, and the shielding box comprises a first ray opening, and the collimator is obliquely inserted into the shielding box with a gap between the two lead plates of the collimator aligned with the first ray opening.

13. A method of mounting a collimator to a collimator mounting device comprising steps of:
cover on the inserting a collimator obliquely into a shielding box along a supporting plate, wherein a transverse plate of a T-shaped base plate in the collimator is placed in grooves of left and right plates, and two opposite sides of the transverse plate are accommodated within left and right adjusting boxes respectively;
adjusting a position of the collimator to align a gap between two lead plates with a first ray opening and a second ray opening;
fixedly connecting the left and right adjusting boxes with the T-shaped base plate, after finely adjusting a position of the T-shaped base plate in the collimator; and
covering a top grooves.

14. The collimator mounting device according to claim 6, wherein, the two lead plates are arranged such that two opposite ends of each lead plate are aligned with one end of the longitudinal plate of the T-shaped base plate and an edge of the transverse plate respectively, and respective outer sides of the lead plates are aligned with two opposite sides of the longitudinal plate respectively.

15. The collimator mounting device according to claim 6, wherein, the T-shaped base plate comprises folded portions at its edges which face the lead plates.

16. The collimator mounting device according to claim 6, wherein, the transverse plate of the T-shaped base plate further comprises fixing holes at its four corners.

17. The collimator mounting device according to claim 16, wherein, each fixing hole is formed as a kidney-shaped slot.

18. The security inspection machine according to claim 11, wherein, the two lead plates are arranged such that two opposite ends of each lead plate are aligned with one end of the longitudinal plate of the T-shaped base plate and an edge of the transverse plate respectively, and respective outer sides of the lead plates are aligned with two opposite sides of the longitudinal plate respectively.

19. The security inspection machine according to claim 11, wherein, the T-shaped base plate comprises folded portions at its edges which face the lead plates.

20. The security inspection machine according to claim 11, wherein, the transverse plate of the T-shaped base plate further comprises fixing holes at its four corners.
